(19) United States
(12) Patent Application Publication
(10) Pub. No.: US 2023/0101246 A1
(43) Pub. Date: Mar. 30, 2023

(54) METHOD AND A SYSTEM FOR PERFORMING A SCAN SKIP OPERATION IN A MULTI-FUNCTION PRINTER (MFP)

(71) Applicant: TOSHIBA TEC KABUSHIKI KAISHA, Tokyo (JP)

(72) Inventor: Gangadhara Reddy JILLELLA, Bangalore (IN)

(73) Assignee: TOSHIBA TEC KABUSHIKI KAISHA, Tokyo (JP)

(21) Appl. No.: 17/944,988

(22) Filed: Sep. 14, 2022

(30) Foreign Application Priority Data
Sep. 24, 2021 (IN) 202141043442

(51) Int. Cl. H04N 1/00; G06F 3/12

(52) U.S. Cl. CPC H04N 1/0092; G06F 3/1205; G06F 3/1258

(57) ABSTRACT

A system for performing an operation of skipping scanning in a multi-function printer (MFP) includes one or more processors and a memory, wherein the memory stores processor-executable instructions, which, on execution, causes the processor to receive job settings for scanning a first set of documents placed in the MFP, suspend a first job for documents after scanning the first set of documents and upon detecting unavailability of a second set of documents, receive activation, by a user, of the operation of skipping scanning and storing the scanned raw data of the first set of documents with a unique identification in the MFP's database. Subsequently, selection of a first job that skipped scanning is determined from jobs that skipped scanning displayed on a display interface of the MFP and scanning of the second set of documents is performed based on the stored job settings for completing the first job.

### TECHNICAL FIELD

The present subject matter is related, in general to Multi-Function Printer (MFP), and more particularly, but not exclusively, to a method and a system for performing a scan skip operation in a Multi-Function Printer (MFP).

### BACKGROUND

A Multi-Function Printer (MFP) is a type of machine that combines the functions of many devices into one. A typical MFP may function as a combination of some or all of the following devices such as photocopier, printer, scanner, network scan, and fax. A scanner device is configured to scan a document provided by a user through Document Feeder (DF) or glass/platen of the MFP. In some instances of MFP operation, user may discover that a few additional set of documents is required to be scanned in addition to sheets of documents already placed in one of the DF or glass/platen of the MFP as part of Network (NW) scanning task. Similar instances may encounter while performing copy and/or Facimile task.

Typically, in order to accommodate additional set of documents, user may pause the scanning task by pressing “continue” icon displayed in user interface of the MFP after completion of scanning of the already placed set of documents. At this point, there is a possibility that a few more documents are not readily available for resuming the scan. As a result of pausing of the MFP operation|, another user cannot begin scanning as part of a new copy/or NW scan or Fax transmission scan until the present user's job is completed or removed/erased/deleted, because the MFP can only execute one scan job at a time. Scanned originals can be copied/produced as a soft document or faxed only after the present user's job is completed. If the present user's job is removed, all previously scanned image data is erased from the MFP's hard drive, and no output is produced. Furthermore, a user with several tasks to complete on the MFP must wait for each individual job to be completed before providing instructions for the subsequent jobs. This would cause inconvenience to the present user and other users waiting to avail the services of the MFP.

The information disclosed in this background of the disclosure section is only for enhancement of understanding of the general background of the invention and should not be taken as an acknowledgement or any form of suggestion that this information forms the prior art already known to a person skilled in the art.

### SUMMARY

The present disclosure is directed to overcome one or more limitations stated above or any other limitation associated with the conventional arts.

In an embodiment of the present disclosure, a method for performing a scan skip operation in a Multi-Function Printer (MFP) is disclosed. The method comprises receiving, by the MFP, job settings for scanning a first set of documents placed in the MFP, associated with a first job. Thereafter, the method comprises suspending, the first job for one or more documents after scanning the first set of documents and upon detecting the unavailability of second set of documents associated with the first set of documents for scanning. Upon suspending the first job, the method comprises receiving activation of a scan skip operation by a user. Subsequently, the method comprises storing a scanned first set of documents [raw data as it is] associated with the first job and associated job settings with a unique Identification (ID) in a database of the MFP upon activating the scan skip operation. Further, the method comprises determining a selection of a scan skipped first job from one or more scan skipped jobs. The one or more scan skipped jobs are displayed on a display interface of the MFP using the unique ID for resuming scanning of the second set of documents, associated with the first job. In an embodiment of the present disclosure, a system for performing a scan skip operation in a Multi-Function Printer (MFP) is disclosed. The system comprises a processor and a memory communicatively coupled to the processor, wherein the memory stores processor-executable instructions, which, on execution, causes the processor to receive job settings for scanning a first set of documents placed in the MFP, associated with a first job. Thereafter, the processor suspends the first job for one or more documents after scanning the first set of documents and upon detecting the unavailability of second set of documents associated with the first set of documents for scanning. The processor receives an activation of a scan skip operation by a user upon suspending the first job. Once the scan skip operation is activated, the processor stores the scanned first set of documents [raw data as it is] associated with the first job and associated job settings with a unique ID in a database of the MFP. Using unique ID, the processor selects a scan skipped first job from one or more scan skipped jobs displayed on a display interface of the MFP for resuming scanning of the second set of documents, associated with the first job. Furthermore, in order to complete the first job, the processor scans the second set of documents based on stored job settings associated with the first set of documents.

In an embodiment of the present disclosure, a non-transitory computer readable medium including instructions stored thereon that when processed by at least one processor causes a system comprising a processor and a memory to receive job settings for scanning a first set of documents placed in the MFP, associated with a first job. Further, the processor suspends the first job for one or more documents after scanning the first set of documents and upon detecting the unavailability of second set of documents associated with the first set of documents for scanning. The processor receives an activation of a scan skip operation by a user upon suspending the first job. Once the scan skip operation is activated, the processor stores the scanned first set of documents [raw data as it is] associated with the first job and associated job settings with a unique ID in a database of the MFP. Using unique ID, the processor selects a scan skipped first job from one or more scan skipped jobs displayed on a display interface of the MFP for resuming scanning of the second set of documents, associated with the first job. Furthermore, in order to complete the first job, the processor scans the second set of documents based on stored job settings associated with the first set of documents. The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1A shows an exemplary environment for performing a scan skip operation in a Multi-Function Printer (MFP), in accordance with some embodiments of the present disclosure.

FIG. 1B shows a block diagram of a system for performing a scan skip operation in a Multi-Function Printer (MFP), in accordance with some embodiments of the present disclosure.

FIG. 2 illustrates a flowchart showing an exemplary method for performing a scan skip operation in a Multi-Function Printer (MFP), in accordance with some embodiments of the present disclosure.

FIG. 3 illustrates a flowchart of a scanning process when a second set of documents is available for scanning, in accordance with some embodiments of the present disclosure.

FIG. 4 shows a flowchart illustrating a method for performing a scan skip operation in a Multi-Function Printer (MFP), in accordance with some embodiments of the present disclosure.

FIG. 5A, FIG. 5B and FIG. 5C are exemplary illustration of display interface of a Multi-Function Printer (MFP), in accordance with some embodiments of the present disclosure.

FIG. 6 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

The terms “comprises”, “comprising”, “includes”, “including” or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method

The present disclosure relates to a method and a system for performing a scan skip operation in a Multi-Function Printer (MFP). At first, a set of documents wished by user is fed into the MFP. The set of documents is provided through one of a Document Feeder (DF) of the MFP or a scanner glass/platen of the MFP. In an embodiment, a user selects the job settings for scanning a first set of documents placed in the MFP, associated with a first job. As an example, consider the first set of documents, say 100 pages to be scanned. Thereafter suspends the first job for one or more documents after scanning the first set of documents. Once the first set of documents has been scanned, the user would like to add a second set of documents in addition to the first set of documents, but the second set of documents is unavailable for scanning, then the method suspends the first job. Thereafter the MFP receives an activation of a scan skip operation by a user upon suspending the first job. Upon activating the scan skip operation, the MFP stores the scanned first set of documents [raw data as it is] associated with the first job and related job/scan settings with a unique Identification (ID) in the MFP's database. Subsequently, the MFP selects a scan skipped the first job from one or more scan skipped jobs. The one or more scan skipped jobs are displayed on the MFP's display interface using the unique ID for resuming scanning of the second set of documents, which are associated with the first job. Furthermore, the MFP performs scanning of the second set of documents based on stored job settings associated with the first set of documents in order to complete the first job.

In this manner, the present disclosure discloses a method and a system for performing a scan skip operation in an MFP which helps to resume scanning from the point at which scanning was skipped when the remaining documents are available for scanning.

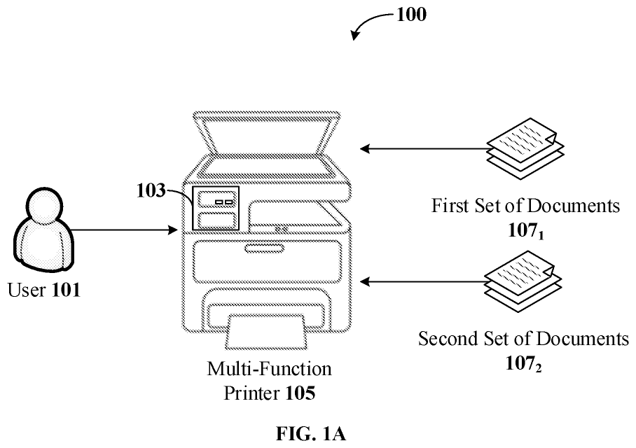

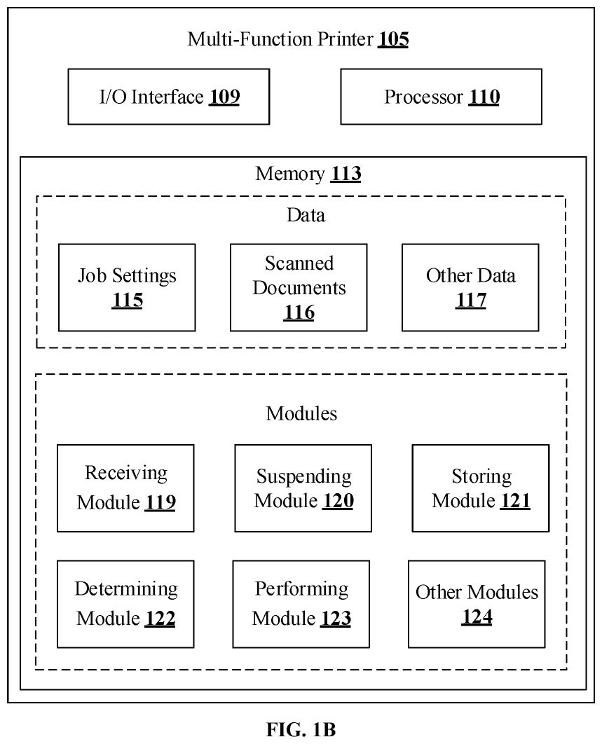

FIG. 1A shows an exemplary environment for performing a scan skip operation in a Multi-Function Printer (MFP), in accordance with some embodiments of the present disclosure.

In an embodiment, an exemplary environment 100 may include, without limiting to, a user 101, a display interface 103, an MFP 105 for scanning a first set of documents 107₁ and a second set of documents 107₂. In an embodiment, the user 101 may be an operator of the MFP 105 and/or a person carrying a set of documents to be scanned at the MFP 105. The MFP 105 comprises a processor 110 interfacing the memory 113 (as shown in FIG. 1B) for performing a scan skip operation in an MFP 105. The MFP 105 may also include an Input/Output (I/O) interface 109 (shown in FIG. 1B).

In an embodiment, an MFP 105 (also referred to as Multi-Function Peripheral, Multi-Function Product, or Multi-Function Device) receives input from a user 101 for scanning one or more sets of documents. As an example, the MFP 105 receives input from the user 101 through a touchpad or a display interface 103, or a keypad associated with the MFP 105. The MFP 105 may be an office printer, a home printer, or any other printer machine that incorporates multiple functionalities. The multiple functionalities including, but are not limited to, printing a document, scanning a document, faxing a document, photocopying a document and the like. The user 101 and the MFP 105 may be physically close together or may be present in the same location, and the user 101 may have direct access to the MFP 105. On the other hand, using a suitable wireless communication and/or wired communication link, the user 101 may access the MFP 105 from a remote location. As an example, the MFP 105 displays a message on the MFP's 105 display interface 103, allowing the user 101 to enter login information, authorizing access to the MFP 105 for scanning the set of documents. When a user 101 logs in to MFP 105, he or she may select one or more job types to scan a set of documents based on the user's 101 need. The one or more job types comprises, a completion copy job type, an asynchronous copy job type, a synchronous copy job type, a network scan job type, a memory fax transmission job type, and a direct fax transmission job type.

In an embodiment, an MFP 105 receives job settings for scanning a first set of documents 107₁ placed in the MFP 105, associated with a first job. As an example, consider the first set of documents 107₁, say 100 pages to be scanned associated with a first job, wherein the first job is referred to as scanning the first set of documents 107₁. The user 101 may enter the job (and/or scan) settings, which comprises color settings, destination device information for storing scanned documents, resolution settings, document size, scanned document format settings, and so on. The user 101 may provide the first set of documents 107₁ through one of a Document Feeder (DF) of the MFP 105 or a scanner glass or platen of the MFP 105. The DF is a function that accepts several pages and feeds the document into the MFP 105 one page at a time, allowing the user 101 to scan multiple-page documents without having to manually replace each page. The platen is a flat glass surface of the MFP 105 on which the user 101 places papers face down on the platen glass for scanning the set of documents one by one.

In an embodiment, after scanning the first set of documents 107₁ completely, MPF 105 suspends a first job for one or more documents. As an example, once the complete first set of documents 107₁ say 100 pages have been scanned, the user 101 would like to add a few more documents in addition to the 100 pages. A few more documents say 20 pages may be provided as a second set of documents 107₂ to the MFP 105. Since the second set of documents 107₂ is continuation to the first set of documents 107₁, there is an association between the first set and second set of documents 107₂ used for scanning. When the user 101 intends to add the second set of documents 107₂ in addition to the first set of documents 107₁, but the second set of documents 107₂ is not readily available for scanning at the time. At this point of operation, the MFP 105 receives an instruction to activate a scan skip operation by the user 101. The activation of scan skip operation is generally performed upon suspending the first job. By utilizing an existing functionality of the MFP 105, the first job is suspended by the user 101 when a next operation, for example, a CONTINUE button, is activated for DF scanning. Similarly, the existing functionality of suspending the first job after each document scan is completed for glass/platen scanning. Upon suspending the first job, the user 101 activates the scan skip operation. Once the scan skip operation is activated, the MFP 105 stores the scanned first set of documents [raw data as it is] 107₁ associated with the first job and related job/scan settings with a unique Identification (ID) in the MFP's 105 database.

In an embodiment, as a part of the storage activity, the user 101 may be requested to enter a unique name with which scanned image data [raw data as it is] and associated scan settings related to the first job may be stored in a database with a unique ID in the current user's 101 account. The database may be part of the MFP 105. Alternatively, the database may be part of the external system which is in communication with the MFP. Subsequently, the user 101 selects a scan skipped first job from one or more scan skipped jobs. As an example, the one or more scan skipped jobs may be displayed on the MFP 105 in a separate tab on a panel/top access—job status view with the user-provided unique ID for resuming scanning of the second set of documents 107₂. The second set of documents 107₂ is associated with the first job. The user 101 places the second set of documents 107₂ (say 20 pages) through one of a DF of the MFP 105 or a scanner glass or platen of the MFP 105 and resumes the scanning process. By using an existing feature of the MFP 105, the user 101 may be allowed to modify the scan settings as per the requirement. When no modifications have been changed in scan settings, then the first job settings may be applied by the MFP 105 for scanning the second set of documents 107₂.

Furthermore, the MFP 105 performs scanning of the second set of documents 107₂ based on stored job settings associated with the first set of documents 107₁ in order to complete the first job. After scanning is completed, the scanned image data may be either printed or saved as a soft document or fax transmitted. This eliminates the requirement for the present user 101 to remove the previously scanned image data and allows subsequent users other than 101 to conduct fresh scanning until the remaining originals become accessible for the present user 101.

In an embodiment, the MFP 105 performs one or more job types when the scan skip operation is activated. The MFP 105 receives user 101 input to execute one or more job types. The one or more job types comprise: a completion copy job type, an asynchronous copy job type, a synchronous copy job type, a network scan job type, a memory fax transmission job type, and a direct fax transmission job type. In the completion copy job type, the print process is performed upon completion of scanning of the first set of documents 107₁ and the second set of documents 107₂. When the MFP 105 scan skip is activated, the scanning process may be skipped and the scanned first set of documents 107₁ data up to that point [raw scanned data as it is] as well as first job settings are saved in an MFP's 105 database. Once the second set of documents 107₂ are available, the scan process may be resumed. After scanning both the first set of documents 107₁ and the second set of documents 107₂ is completed, then the printing process may be initiated. As a result, documents may be printed for all copies both before and after the MFP 105 scan skip. For example, suppose the user 101 wishes to print two books, each of 100 pages, and then initiate the scanning process. The printing process begins when the scanning of two books has been completed.

In an embodiment, in asynchronous copy job type, when the scan skip operation is activated, the scanning and printing processes are skipped and the scanned first set of documents 107₁ data up to that point [raw scanned data as it is] as well as first job settings are saved in an MFP's 105 database and the first set of documents 107₁ which are scanned until the activation of the skip operation is printed. When the second set of documents 107₂ is available, the scanning and printing processes are resumed, and the second set of documents 107₂ is printed associated with the first set of documents 107₁. For example, if the number of photocopies exceeds one, the whole set of documents scanned will be printed for the next photocopies. For example, the user 101 may prefer to print several copies of the same documents, such as two copies of the same book, or user 101 may wish to take more than one photocopy of the same document (say 2 copies), or user 101 may prefer to change the color setting from Full color/Black and White to Auto color or vice versa in the job.

In an embodiment, in a synchronous copy job type, both scanning and printing processes are executed simultaneously for the same page. When the scan skip operation is activated scanning and printing processes are terminated upon scanning and printing process of the last page of the first set of documents 107₁ are completed. The first job may be terminated, and the user 101 will be able to collect the printed documents. For example, suppose the user 101 wishes to print 50 pages documents, and then initiate the scanning process. Once the scanning process for the last page, say the 50^{th} page, is completed and the scan job for one or more documents is suspended, then the user 101 will be able to collect the printed 50 pages documents. Upon activating scan skip feature, the synchronous copy is terminated so that another synchronous copy can be executed by the user until second set of documents 107₂ is available, as at a time, MFP can execute only one synchronous copy job and synchronous copy is the most frequently executed copy job. When a second set of documents 107₂ are available with the user 101 for scanning, both scanning and printing processes are resumed as a new job. The user 101 may not need to store the scanned image data [raw data as it is] in the MFP 105 database, because the last page of the document is completely processed [scanned and printed] before the scan skip operation is activated, instead, only the job settings may be stored in the MFP 105 database. Also, if scan or print resource is unavailable at the time of resuming the first job, the task may not be completed synchronously; in this instance, the user 101 may be offered the option of completing the job as an asynchronous copy job type if MFP decides that job cannot be executed as synchronous copy depending on the conditions for synchronous copy. For example, consider a set of documents is provided through one of DF or glass/platen of the MFP 105 for scanning; another copy scanning or network print is running when scan skipped synchronous copy job is resumed in which case the second set of documents are executed in asynchronous copy mode or the user 101 may wish to change the document color settings (say from Full Color/Black and White to Auto Color) in which case the second set of documents are executed in asynchronous copy mode.

In an embodiment, in a network scan job type, both scanning process and data conversion to required format or file storage processes are running simultaneously. When the scan skip operation is activated scanning and data conversion, or file storage processes are skipped upon scanning of the last page of the first set of documents 107₁ is completed. The scanned first set of documents 107₁ [raw scanned data as it is] and job settings are stored in the MFP database and the intermediate outputs of data conversion and file storage processes are deleted from MFP database. The scanning and data conversion or file storage processes are resumed once a second set of documents 107₂ is available for scanning and complete the processing of all the documents before and after scan skip operation is activated. For example, the user 101 may store scanned document from MFP 105 to local storage or store it in a network folder via a network.

In an embodiment, in a memory fax transmission job type, when the scan skip operation is activated scanning process of the first set of documents 107₁ is skipped. The scanning process may be resumed once the user 101 has access to a second set of documents 107₂ for scanning. After the scan process has been completed, the fax transmission process may begin, which will allow all scanned documents [both before and after the activation of scan skip operation] to be faxed.

In an embodiment, in a direct fax transmission job type, when the scan skip operation is activated, scanning of the last page of a first set of documents 107₁ and fax transmission of the first set of documents 107₁ are completed. Thereafter both the scanning and fax transmission processes are terminated and only the job settings are stored in the MPF's 105 database. The user 101 may not be required to store the scanned image data [raw scanned data] in the database because the last page before the MFP 105 scan skip is completely processed [scanned and fax transmitted]. When a second set of scanned documents 107₂ is available for scanning, scanning and fax transmission processes are resumed as a new job. Furthermore, when resuming, there is a chance that the job may be unable to be completed in direct fax transmission mode if a fax line is not readily available at that time or conditions for direct fax transmission are not satisfied; in this instance, the user 101 will be offered the option to execute it as a memory fax transmission job type.

FIG. 1B shows a block diagram of a system for performing a scan skip operation in a Multi-Function Printer (MFP), in accordance with some embodiments of the present disclosure.

In some implementations, a MFP 105 receives data through an I/O interface 109. As an example, the received data is stored within memory 113. In an embodiment, the data stored in the memory may include job settings 115, scanned documents 116, and other data 117. In the illustrated FIG. 1B, one or more modules stored in memory 113 are described herein in detail.

In one embodiment, the data may be stored in memory 113 in the form of various data structures. Additionally, the aforementioned data can be organized using data models, such as relational or hierarchical data models. The other data 117 may store data, including various temporary data and temporary files, generated by modules for performing the various functions of the MFP 105. As an example, the other data 117 may include, without limitation, temporarily stored user 101 input and buffers generated while scanning the set of documents.

In an embodiment, the job settings 115 include settings associated with each scanning document/job. The job settings 115 comprises at least one of the settings, destination device information for storing scanned documents, resolution settings, and document size.

In an embodiment, the scanned documents 116 may be the raw data that is created by scanning the first set of documents 107₁ related to the first j ob. In an embodiment, the scanned documents 116 may be stored in a database of the MFP 105 with a unique ID which will be used to identify the currently scanned documents.

In an embodiment, the data stored in memory 113 are processed by the modules of the MFP 105. The modules may be stored within the memory 113 as shown in FIG. 1B. In an example, the modules, communicatively coupled to the processor 110, may also be present outside the memory 113.

In one implementation, the modules may include, for example, a receiving module 119, a suspending module 120, a storing module 121, a determining module 122, a performing module 123, and other modules 124. The other modules 124 may be used to perform various miscellaneous functionalities of the MFP 105. It will be appreciated that such aforementioned modules may be represented as a single module or a combination of different modules.

In an embodiment, the receiving module 119 may be configured to receive job settings 115 from the user 101 for scanning a first set of documents 107₁ placed in the MFP 105, associated with a first job. The job settings 115 comprises at least one of the settings, destination device information for storing scanned documents, resolution settings for scanning set of documents, and document size. The first set of documents 107₁ are provided through one of a Document Feeder (DF) of the MFP 105 or a scanner glass/platen of the MFP 105. The receiving module 119 may also be configured to receive an activation of a scan skip operation by a user 101 upon suspending the first job.

In an embodiment, the suspending module 120 may be configured to suspend a first job for one or more documents after scanning the first set of documents 107i and upon detecting unavailability of a second set of documents 107₂. The second set of documents 107₂ are associated with the first set of documents 107₁ for scanning.

In an embodiment, the storing module 121 may be configured to store the scanned first set of documents 107₁ associated with the first job and associated job settings with a unique ID in a database of the MFP 105 upon activating the scan skip operation.

In an embodiment, the determining module 122 may be configured to determine a selection of a scan skipped first job from one or more scan skipped jobs displayed on a display interface of the MFP 105. The MFP 105 resumes scanning of a second set of documents 107₂, associated with the first job using the unique ID.

In an embodiment, the performing module 123 may be configured to perform scanning a second set of documents 107₂ placed on the MFP 105 based on stored job settings 115 associated with the first set of documents 107₁ for completing the first job. The second set of documents 107₂ are provided through one of a DF of the MFP 105 or a scanner glass or platen of the MFP 105. The performing module 123 may also be configured to perform one or more job types when the scan skip operation is activated. The one or more job types comprises, a completion copy job type, an asynchronous copy job type, a synchronous copy job type, a network scan job type, a memory fax transmission job type, and a direct fax transmission job type.

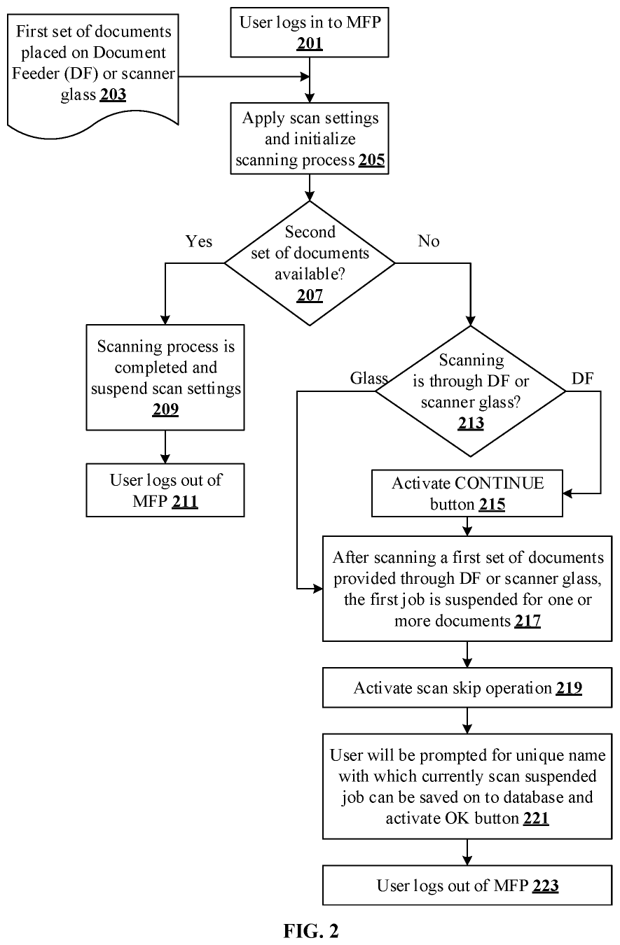

FIG. 2 illustrates a flowchart showing an exemplary method for performing a scan skip operation in a Multi-Function Printer (MFP), in accordance with some embodiments of the present disclosure.

At block 201, when a user 101 wishes to scan a set of documents, the method prompts the user 101 to log in to the MFP 105. At block 203, a first set of documents 107₁ are provided through one of a DF of the MFP 105 or a scanner glass/platen of the MFP 105 and then the method proceeds to block 205. At block 205, the method receives job/scan settings for scanning the first set of documents 107₁ placed in the MFP 105 and initializes the scanning process. At block 207, the methods verify that the second set of documents 107₂ associated with the first set of documents 107₁ are available for scanning. If the second set of documents is available for scanning, then the method proceeds to block 209. The method proceeds to block 213 if the second set of documents 107₂ is not readily available for scanning. At block 209, after scanning the first and second sets of documents 107₁ and 107₂, the method proceeds to block 211. At block 211, as the job is completed, the method allows the user 101 to log out of MFP 105. At block 213, the method verifies that the second set of documents 107₂ is provided through a DF of the MFP 105 or a scanner glass/platen of the MFP 105. If the second set of documents 107₂ is provided through a scanner glass/platen of the MFP 105, the method proceeds to block 217. If the second set of documents is provided through the DF of the MFP 105, the method proceeds to block 215. The method activates a CONTINUE button for the DF scanning process at block 215 and then proceeds on to block 217. At block 217, the method suspends the first job for scanning one or more documents after scanning the first set of documents 107₁ provided through the DF of the MFP 105 or scanner glass/platen of the MFP 105 and proceeds to block 219. Following the suspension of the first job, the method receives an activation of a scan skip operation by a user 101 at block 219 and continues to block 221. At block 221, the method prompts the user 101 to choose a unique name which will be used to identify the currently suspended scan job in the MFP's 105 database and activate an OK button. Once the Ok button is activated, the method proceeds to block 223. At block 223, after storing the scanned raw data and job settings, the method allows the user 101 to log out of MFP 105.

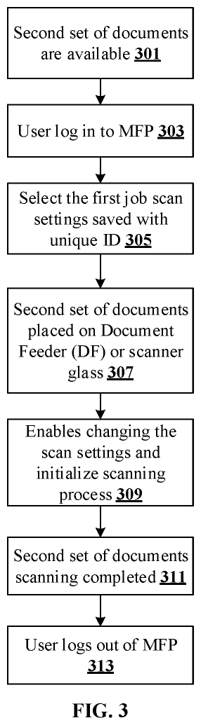

FIG. 3 illustrates a flowchart of a scanning process when a second set of documents is available for scanning, in accordance with some embodiments of the present disclosure. At block 301, when a second set of documents is accessible/available to the user 101 which is associated with the first set of documents 107₁, then the method begins the scanning process. At block 303, once the user 101 has access to the second set of documents 107₂, the method prompts the user 101 to log in to the MFP 105, and then the method proceeds to block 305. At block 305, the method selects the first job scan settings which have been saved in a database with a unique identification for resuming scanning the second set of documents 107₂. At block 307, the second set of documents 107₂ are provided through one of a DF of the MFP 105 or a scanner glass/platen of the MFP 105 and then the method proceeds to block 309. At block 309, while scanning the second set of documents 107₂, the method enables the user 101 to change the scan settings if required and begin the scanning process. At block 311, the method performs scanning of the second set of documents 107₂ placed on the MFP 105. After the scanning process is completed, the method performs post-processing, such as storing the scanned image data, including that of before and after scan skip, in the desired format (for example, pdf, tiff, and so on) in the case of Network Scan job, printing the data in the case of copy job, or fax transmitting the data in the case of Fax transmission job. In the case of glass/platen, the second set of documents 107₂ can be scanned one after the other as usual, and then the method may be procced to block 313. At block 313, upon completion of scanning the second set of documents 107₂, the method allows the user 101 to log out of MFP 105.

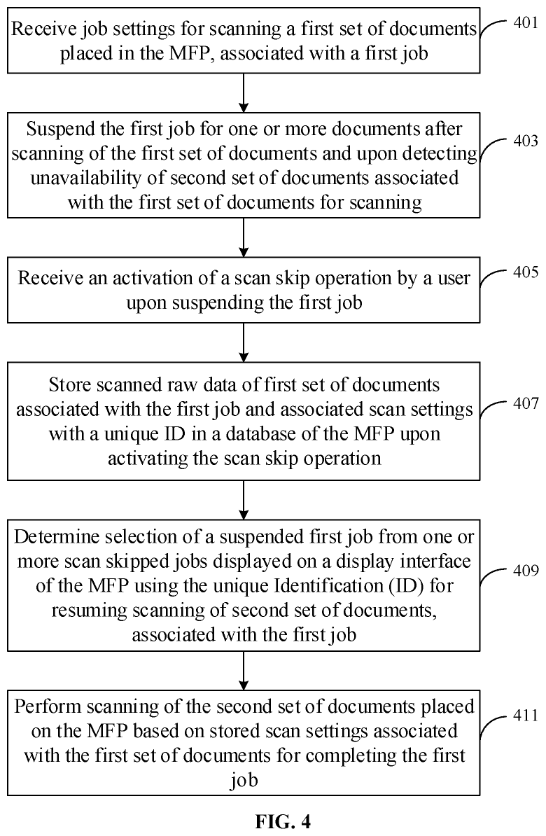

FIG. 4 shows a flowchart illustrating a method for performing a scan skip operation in a Multi-Function Printer (MFP), in accordance with some embodiments of the present disclosure.

As illustrated in FIG. 4, the method comprises one or more blocks for performing a scan skip operation in an MFP 105. The method may be described in the general context of computer executable instructions. Generally, computer executable instructions can include routines, programs, objects, components, data structures, procedures, modules, and functions, which perform particular functions or implement particular abstract data types.

The order in which the method is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 401, the method comprises receiving, by the MFP 105, job settings for scanning a first set of documents 107₁ placed in the MFP 105, associated with a first job. As an example, job settings for scanning documents comprises at least one of the settings, destination device information for storing scanned documents, resolution settings, brightness settings, and document size. The first set of documents 107₁ are provided through one of a DF of the MFP 105 or a scanner glass/platen of the MFP 105.

At block 403, the method comprises suspending, by the MFP 105, the first job for one or more documents after scanning of the first set of documents 107₁ and upon detecting unavailability of a second set of documents 107₂ associated with the first set of documents 107₁ for scanning. The first set of documents 107₁ and second set of documents 107₂ are provided through one of a DF of the MFP 105 or a scanner glass/platen of the MFP 105. The first job is suspended when a CONTINUE button is activated for DF scanning and the first job is suspended after scanning each document for glass/platen scanning.

At block 405, the method comprises receiving, by the MFP 105, activation of a scan skip operation by a user 101 upon suspending the first job. As an example, while scanning a first set of documents 107₁, a user 101 realizes that he or she needs to scan a second set of documents 107₂ along with the first set of documents 107₁.

At block 407, the method comprises storing, by the MFP 105, scanned first set of documents [raw data as it is] 107₁ associated with the first job and associated job settings with a unique ID in a database of the MFP 105 upon activating the scan skip operation.

At block 409, the method comprises determining, by the MFP 105, selection of a scan skipped a first job from one or more scan skipped jobs displayed on a display interface 103 of the MFP 105 using the unique ID for resuming scanning of a second set of documents 107₂, associated with the first job.

At block 411, the method comprises performing, by the MFP 105, scanning of the second set of documents 107₂ placed on the MFP 105 based on stored first job settings. The first job setting is associated with the first set of documents 107₁ for completing the first job. Upon resuming the first job, the method also performs one or more job types. The one or more job types comprises a completion copy job type, an asynchronous copy job type, a synchronous copy job type, a network scan job type, a memory fax transmission job type, and a direct fax transmission job type.

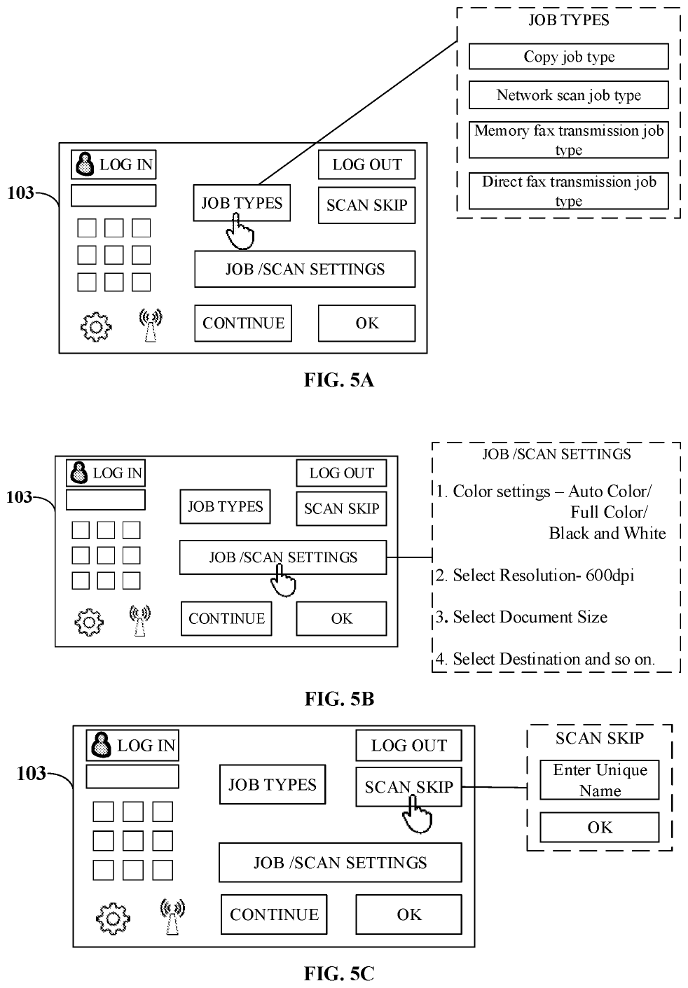

FIG. 5A, FIG. 5B and FIG. 5C are exemplary illustration of display interface of a Multi-Function Printer (MFP), in accordance with some embodiments of the present disclosure.

FIG. 5A shows an exemplary display interface 103 of an MFP 105 that may be used for receiving the user input from the user 101. In an embodiment, the display interface 103 on the MFP 105 may provision one or more buttons for each of one or more operations. The one or more buttons may include, without limiting to, user log in and log out button, job types button, scan skip button, job/scan settings button, continue button and OK button for assisting the user 101 in entering the required user input. Using the one or more buttons, the user 101 may be provisioned to select a desired operation from the one or more operations. As shown in the FIG. 5A, a button “LOGIN” may be selected by the user 101 to enter login information, authorizing access to the MFP 105 for scanning the set of documents. The “LOG OUT” button may also be selected by the user 101 to exit the MFP 105 after scanning the set of documents. The set of documents are provided through one of a DF of the MFP 105 or a scanner glass or platen of the MFP 105.

In an embodiment, after log into an MFP 105, user 101 may select a “JOB TYPES” button to scan a set of documents based on the user's 101 requirements (FIG. 5A). The job types comprise: copy job type, a network scan job type, a memory fax transmission job type, and a direct fax transmission job type. Copy job type is internally decided by MFP, based on job settings or current jobs running or H/W status, as the “COMPLETION JOB TYPE”, in which case, printing process is initiated after the first set of documents 107₁ and the second set of documents 107₂ have been scanned; for example, if the job includes Magazine sort setting or “ASYNCHRONOUS COPY JOB TYPE”, in which case, the scanning and printing process are executed simultaneously with the scan process ahead of the printing process by few pages; for example, if the job includes more than 1 photocopy, or Auto color setting, or “SYNCHRONOUS COPY JOB TYPE”, in which case, both printing and scanning are executed simultaneously; for example, if the job includes 1 photocopy, Full color/Black and White and other settings needed for synchronous copy. Suppose the user 101 wishes to send the scanned documents to e-mail or store the scanned documents on to local hard disk or network drive, then the user 101 may select the “NETWORK SCAN JOB TYPE” button. Similarly, if the user 101 wishes to send the scanned documents through fax transmission, then the user 101 may select either the “MEMORY FAX TRANSMISSION JOB TYPE” or the “DIRECT FAX TRANSMISSION JOB TYPE” button based on the user's 101 requirements.

For example, suppose a user 101 wishes to scan a set of documents (say a first set of documents 107₁ contains 100 pages), and then initiate the scanning process. The set of documents are provided through one of a DF of the MFP 105 or a scanner glass/platen of the MFP 105. Thereafter user 101 may select a “JOB/SCAN SETTING” button to provide scan settings for scanning the first set of documents. As shown in FIG. 5B, the user 101 may select color settings (say Auto color, full color or black and white or grayscale), resolution (say 600 dpi or 300 dpi), document size, and destination device information is shown in Table 1 below. For example, user 101 prefers to scan the first set of documents in Auto color and Magazine sort settings initiates the scanning process.

TABLE 1

| JOB NO. | JOB TYPE | JOB/SCAN SETTING |
|---|---|---|
| 1 | COPY JOB TYPE | Auto color, Magazine sort |
| | | setting, Print paper size and |
| | | other settings. |
| 2 | NETWORK SCAN | Color, 600 dpi, .pdf file format, |
| | JOB TYPE | Destination for storing the .pdf |
| | | files and other settings. |
| 3 | MEMORY FAX | Standard/Fine/Ultra Fine |
| | TRANSMISSION | Resolution, Destination |
| | JOB TYPE | Telephone number and |
| | | other settings. |
| 4 | DIRECT FAX | Standard/Fine/Ultra Fine |
| | TRANSMISSION | Resolution, Destination |
| | JOB TYPE | Telephone number and |
| | | other settings. |

After scanning the first set of documents 107₁, user 101 realizes another set of documents (say a second set of documents 107₂ contains 50 pages) needs to be scanned in addition to the first set of documents 107₁. When the second set of documents 107₂ is unavailable for scanning, then user 101 suspends the first job for one or more documents. The existing functionality of suspending the first job after each document is scanned is completed for glass/platen scanning. Similarly, by utilizing an existing functionality of the MFP 105, the first job is suspended by the user 101 when a CONTINUE button is activated for DF scanning.

Thereafter, user 101 initiates a scan skip operation by activating a “SCAN SKIP” button after suspending the first job as shown in FIG. 5C. As shown the FIG. 5C, the user 101 is then prompted to enter a unique Identification (ID) for storing the raw scanned data of first set of documents 107₁ (say 100 pages) and first job/scan settings in a database of the MFP 105 as shown in Table 2 below.

TABLE 2

| JOB NO. | Unique ID | Job Settings |
|---|---|---|
| 1 | SCANSKIP_JOB0001_20210731_201032_Project1 | Auto color, Magazine sort |
| | | setting, Print paper size and |
| | | other settings. |
| 2 | SCANSKIP_JOB0282_20211020_181215_HouseConstruction | Color, 600 dpi, .pdf file format, |
| | | Destination for storing the .pdf |
| | | files and other settings. |
| 3 | SCANSKIP_JOB0999_20220201_120540_HomeWork | Standard/Fine/Ultra Fine |
| | | Resolution, Destination |
| | | Telephone number and |
| | | other settings. |
| 4 | SCANSKIP_JOB9999_20231231_094559 | Standard/Fine/Ultra Fine |
| | | Resolution, Destination |
| | | Telephone number and |
| | | other settings. |

Unique ID is auto generated by the MFP in the format “SCANSKIP_JOBXXXX_YYYYMMDD_hhmmss_<arbitrary name>” as mentioned above in few examples where XXXX is JOB NUMBER which can be started from 0000 to 9999; after 9999 max scan skip jobs are reached, the oldest saved scan skip by date is deleted; where YYYY indicates year in 4-digit format, MM indicates month in 2-digit format and DD indicates day in 2-digit format; where hh indicates hours in 2-digit format, mm indicates minutes in 2-digit format and ss indicates seconds in 2-digit format; where YYYYMMDD and hhmmss reflect the date and time respectively when scan skip is activated by the user; where “arbitrary name” is name given by user for easy identification—this is optional though; if user wishes, he/she can input arbitrary name.

In an embodiment, once a user 101 has access to a second set of documents 107₂ (say 20 more pages) which is associated with the first set of documents 107₁, then selects the first job scan settings which have been saved in a database. For example, the user selects the first job scan setting which has been saved in a database with a unique ID say SCANSKIP_JOB0001_20210731_201032_Projectl (corresponding job settings—Auto color, Magazine sort setting, Print paper size and other settings) for resuming scanning the second set of documents 107₂. The second set of documents 107₂ is provided through one of a DF of the MFP 105 or a scanner glass/platen of the MFP 105. Upon completion of scanning the second set of documents 107₂, in this case, as it is a completion copy due to Magazine sort setting, complete scanned documents are printed in magazine format after both first and second sets of documents are scanned after which the user 101 can log out of MFP 105.

Complete Scanned Documents=First Set of Documents+Second Set of Documents

### Computer System

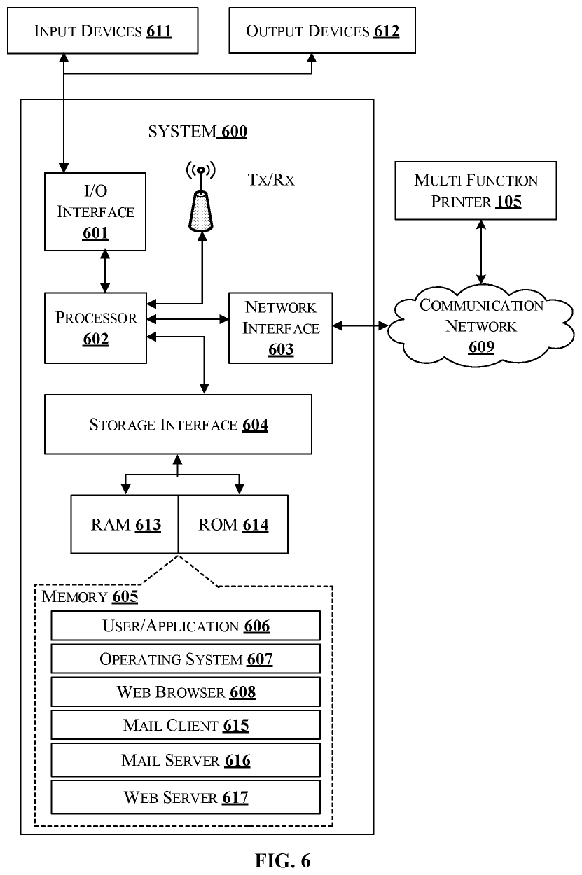

FIG. 6 illustrates a block diagram of an exemplary computer system 600 for implementing embodiments consistent with the present disclosure. In an embodiment, the computer system 600 may be an MFP 105 illustrated in FIG. 1 which may be used for performing a scan skip operation in a MFP 105. The computer system 600 may include a central processing unit (“CPU” or “processor”) 602. The processor 602 may comprise at least one data processor for executing program components for executing user or system-generated business processes. The processor 602 may include specialized processing units such as integrated system (bus) controllers, memory management control units, floating point units, graphics processing units, digital signal processing units, etc.

The processor 602 may be disposed in communication with one or more input/output (I/O) devices (611 and 612) via I/O interface 601. The I/O interface 601 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 601, the computer system 600 may communicate with one or more I/O devices 611 and 612.

In some embodiments, the processor 602 may be disposed in communication with a communication network 609 via a network interface 603. The network interface 603 may communicate with the communication network 609. The network interface 603 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc.

The communication network 609 can be implemented as one of the several types of networks, such as intranet or Local Area Network (LAN) and such within the organization. The communication network 609 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 609 may include a variety of network devices, including routers, bridges, servers, computing devices, storage devices, etc.

In some embodiments, the processor 602 may be disposed in communication with a memory 605 (e.g., RAM 613, ROM 614, etc. as shown in FIG. 6) via a storage interface 604. The storage interface 604 may connect to memory 605 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 605 may store a collection of program or database components, including, without limitation, user/application 606, an operating system 607, a web browser 608, mail client 615, mail server 616, web server 617 and the like. In some embodiments, computer system 600 may store user/application data 606, such as the data, variables, records, etc. as described in this invention. Such databases may be implemented as fault-tolerant, relational, scalable, secure databases such as Oracle^{R} or Sybase^{R}.

The operating system 607 may facilitate resource management and operation of the computer system 600. Examples of operating systems include, without limitation, APPLE MACINTOSH^{R} OS X, UNIX^{R}, UNIX-like system distributions (E. G., BERKELEY SOFTWARE DISTRIBUTION™ (BSD), FREEBSD™, NETBSD™, OPENBSD™, etc.), LINUX DISTRIBUTIONS™ (E. G., RED HAT™, UBUNTU™, KUBUNTU™, etc.), IBM™ OS/2, MICROSOFT™ WINDOWS™ (XP™, VISTA™/7/8, 10 etc.), APPLE^{R} IOS™, GOOGLE^{R} ANDROID™, BLACKBERRY^{R} OS, or the like. A user interface may facilitate display, execution, interaction, manipulation, or operation of program components through textual or graphical facilities. For example, user interfaces may provide computer interaction interface elements on a display system operatively connected to the computer system 600, such as cursors, icons, check boxes, menus, windows, widgets, etc. Graphical User Interfaces (GUIs) may be employed, including, without limitation, APPLE MACINTOSH^{R} operating systems, IBM™ OS/2, MICROSOFT™ WINDOWS™ (XP™, VISTA™/7/8, 10 etc.), Unix^{R} X-Windows, web interface libraries (e.g., AJAX™, DHTML™, ADOBE® FLASH™, JAVASCRIPT™, JAVA™, etc.), or the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

In an embodiment, the present disclosure provides a method and system for performing a scan skip operation in a Multi-Function Printer (MFP).

In an embodiment, the present disclosure provides a new scan skip feature to skip the suspended scanning that can be provided to the user. Scan skip can be used when few more originals need to be scanned and they are not available readily and scanning can be resumed later on when the remaining originals are available.

In an embodiment, the present disclosure helps to resume scanning from the point at which scanning was skipped when the remaining originals are available which saves the user time and effort.

In an embodiment, the present disclosure allows a new copy/a network scan/a fax job which involves scanning to be executed by using scan skipping a first job without keeping the first job in scan suspended for a long time.

In an embodiment, the present disclosure is extremely useful when a second set of documents is to be added to first set of scanned documents.

In an embodiment, the present disclosure improves user convenience and enhances user experience with the scanning.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise. The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for performing an operation of skipping scanning in a multi-function printer, the method comprising:
receiving job settings for scanning a first set of documents placed in the multi-function printer, associated with a first job;
suspending the first job for one or more documents after scanning of the first set of documents and in response to detecting unavailability of a second set of documents associated with the first set of documents for scanning;
receiving an activation, by a user, in response to suspending the first job, of the operation of skipping scanning;
storing scanned raw data of the first set of documents associated with the first job and associated job settings with a unique identification in a database of the multi-function printer in response to activating the operation of skipping scanning;
determining selection of a first job that skipped scanning from one or more jobs that skipped scanning displayed on a display interface of the multi-function printer using the unique identification for resuming scanning of the second set of documents, associated with the first job; and
performing scanning of the second set of documents placed on the multi-function printer based on the stored job settings associated with the first set of documents for completing the first job.

2. The method of claim 1, wherein the job settings comprise at least one of destination device information for storing scanned documents, resolution settings or a document size.

3. A system for performing an operation of skipping scanning in a multi-function printer, the system comprising:
one or more processors; and
a memory communicatively coupled to the one or more processors, wherein the memory stores processor-executable instructions, which, on execution, causes the one or more processors to:
receive job settings for scanning a first set of documents placed in the multi-function printer, associated with a first job;
suspend the first job for one or more documents after scanning of the first set of documents and in response to detecting unavailability of a second set of documents associated with the first set of documents for scanning;
receive an activation, by a user, of an operation of skipping scanning in response to suspending the first job;
store scanned raw data of the first set of documents associated with the first job and associated job settings with a unique identification in a database of the multi-function printer in response to activating the operation of skipping scanning;
determine selection of a first job that skipped scanning from one or more jobs that skipped scanning displayed on a display interface of the multi-function printer using the unique identification for resuming scanning of the second set of documents, associated with the first job; and
perform scanning of the second set of documents based on the stored job settings associated with the first set of documents for completing the first job.

4. The system of claim 3, wherein the job settings comprise at least one of destination device information, resolution settings, or a document size.

5. The system of claim 3, wherein the multi-function printer is configured such that first set of documents and the second set of documents are provided through at least one of a document feeder of the multi-function printer or a scanner glass of the multi-function printer.

6. The system of claim 3, wherein the one or more processors enable scanning a new set of documents associated with a new job in response to the first job being skipped for scanning.

7. The system of claim 3, wherein the one or more processors enable changing scan settings using an existing feature in response to scanning the second set of documents.

8. The system of claim 3, wherein the one or more processors suspend the first job for additional original documents using an existing feature in response to a next operation being activated for scanning through a document feeder and using the existing feature of suspending the scanning of each document for scanning through a scanner glass.

9. The system of claim 3, wherein the one or more processors perform one or more job types in response to the operation of skipping scanning being activated, wherein the one or more job types comprise: copy job type internally executed as at least one of a network scan job type, a memory fax transmission job type, a direct fax transmission job type, or a completion copy, wherein the completion copy may be an asynchronous copy or a synchronous copy.

10. The system of claim 9, wherein, in the completion copy, the one or more processors are configured to perform a print process in response to completion of scanning of the first set of documents and the second set of documents.

11. The system of claim 9, wherein, in the asynchronous copy, the one or more processors are configured to skip a scanning and printing process in response to the operation of skipping scanning being activated, and the first set of documents which is scanned until the activation of the operation of skipping scanning being printed.

12. The system of claim 11, wherein the one or more processors resume the scanning and printing process in response to the second set of documents being available and the printed second set of documents being associated with the first set of documents.

13. The system of claim 9, wherein, in the synchronous copy, the one or more processors are configured to terminate the scanning and printing processes in response to the operation of skipping scanning being activated.

14. The system of claim 13, wherein the one or more processors terminate the scanning and printing processes in response to a scanning and printing process of the last page of the first set of documents being completed, and the first job being terminated.

15. The system of claim 13, wherein the one or more processors resume the scanning and printing process as a new job in response to the second set of documents being available for scanning.

16. The system of claim 9, wherein, in the network scan job type, the one or more processors are configured to skip scanning and a data conversion or a file storage process in response to the operation of skipping scanning being activated and in response to scanning of the last page of the first set of documents being completed, and the scanned data of the first set of documents being stored in the database.

17. The system of claim 16, wherein the one or more processors resume the scanning and the data conversion or the file storage process in response to the second set of documents being available for scanning.

18. The system of claim 9, wherein, in the memory fax transmission job type, the one or more processors are configured to skip the scanning process of the first set of documents and perform a fax transmission process in response to the operation of skipping scanning being activated.

19. The system of claim 9, wherein, in the direct fax transmission job type, the one or more processors are configured to terminate scanning and fax transmission processes in response to the operation of skipping scanning being activated and in response to scanning of the last page of the first set of documents and fax transmission of the first set of documents being completed.

20. A non-transitory computer readable medium including instructions stored thereon that when processed by at least one processor causes a system comprising a processor and a memory to:
receive job settings for scanning a first set of documents placed in the multi-function printer, associated with a first job;
suspend the first job for one or more documents after scanning of the first set of documents and in response to detecting unavailability of a second set of documents associated with the first set of documents for scanning;
receive an activation, by a user, in response to suspending the first job, of an operation of skipping scanning;
store scanned raw data of the first set of documents associated with the first job and associated job settings with a unique identification in a database of the multi-function printer in response to activating the operation of skipping scanning;
determine selection of a first job skipped scanning from one or more jobs skipped scanning displayed on a display interface of the multi-function printer using the unique identification for resuming scanning of the second set of documents, associated with the first job; and
perform scanning of the second set of documents based on the stored job settings associated with the first set of documents for completing the first job.
